(19) United States
(12) Patent Application Publication
(10) Pub. No.: US 2022/0295757 A1
(43) Pub. Date: Sep. 22, 2022

(54) Bird or Hummingbird Feeder Nesting Pole

(71) Applicant: Brian Hentschel, Markham (CA)

(72) Inventor: Brian Hentschel, Markham (CA)

(21) Appl. No.: 17/207,612

(22) Filed: Mar. 20, 2021

(51) Int. Cl. A01K 39/02

(52) U.S. Cl. CPC A01K 39/0206

(57) ABSTRACT

The present invention relates to a simple, inexpensive and easy to use design which assists in filling the bird or hummingbird feeders which are nested on poles. The assembly provides tubes of varying lengths which are nested within each other and when the filling operation is required, the smaller tube nested within the larger tube can slide together, lowering the height to facilitate an easy feed filling process for users.

### COPYRIGHT NOTICE

A portion of the disclosure of this patent document contains material which is subject to copyright protection. The copyright owner has no objection to the facsimile reproduction by anyone of the patent disclosure, as it appears in the Patent and Trademark Office patent files or records, but otherwise reserves all copyright rights whatsoever.

### BACKGROUND

### Field of the Invention

This invention relates to an easy sliding nesting pole which works with any bird or hummingbird feeder to make it easy to fill and refill the feed and then raise the feeder to the desired height.

### Description of the Related Art

With an increasing senior population there is a growing interest in attracting and watching birds. The most effective method of attracting birds is to provide an attractive environment, which includes a suitable nesting site, minimization of predators, and provision for feed. Numerous bird feeders have been developed for the purpose of attracting birds to a particular site. However, a common problem is keeping the bird or hummingbird feeder at a good height, and how to refill the feeder when it is at that height. Filling and refilling requires feeders to be at a desired height. This can be cumbersome and precarious.

There have been a number of effective bird feeder inventions with the focus on deterring squirrels. The focus of this system is different as it focuses on making it easy to fill and refill the bird or hummingbird feeder.

Nesting poles do exist for other applications (i.e. a cane), but have not been used for this application.

The advantage of this system is a pole which can assist with any type of bird or hummingbird feeder. The assembly is easy to use, and it promotes a simple, practical and inexpensive way to fill the bird feeders. This innovative approach makes it easy to add bird feed, and then raise it up once the filling process is completed.

### SUMMARY

The primary objective is to provide a novel and improved form of assembly which allows the user to lower the bird or hummingbird feeder to a height at which feed can be added easily. Once the feed is added the feeder can be raised to the desired height for attracting birds.

Another objective of the assembly is that it is universal and works with any type of bird or hummingbird feeder.

Another objective is that it can be manufactured easily at low cost (it is two poles and a pin), thereby making it attractive to the general public.

Also, it is intended to be easy to use and convenient for everyone.

This Summary is provided merely for the purpose of summarizing some example embodiments, in order to provide a basic understanding of some aspects of the subject matter described herein. Accordingly, it will be appreciated that the above-described features are merely examples, and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 100 is a full view of the simple nested bird feeder pole.

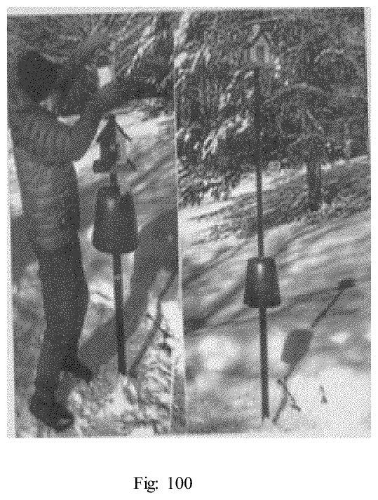

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

The present invention is directed to provide an improved pole assembly which can support any bird or hummingbird feeder.

A further problem associated with bird feeders is the technique required to fill the bird feeder. Filling and refilling requires special pre-requisites. Climbing high places requires the user to arrange a ladder and add food in the feeder assembly.

The pole assembly consists of poles of varying lengths and diameters. The smaller diameter tube is nested inside of the larger diameter tube for filling. The user can remove the pin to lower the pole down for refilling. The proposed pole system provides a simple, easy to use and inexpensive method of filling bird feeders.

Having described the invention in detail, those skilled in the art will appreciate that modifications may be made to the invention without departing from its spirit. Therefore, it is not intended that the scope of the invention be limited to the specific embodiment illustrated and described here. Rather, it is intended that the scope of this invention be determined by the appended claims and their equivalents.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

1. A system and method of providing easy to fill nested bird feeder pole, comprising:
(a) a smaller diameter tube;
(b) a larger diameter tube;
(c) a pin to lock the position of tubes
where the smaller diameter tube is nested within the larger diameter tube and can be extended for easy filling. The smaller diameter tube holds the bird feeder. It can be lowered for easy filling and can be raised up once filling is completed.
